(19) United States
(12) Patent Application Publication
(10) Pub. No.: US 2025/0170833 A1
(43) Pub. Date: May 29, 2025

(54) PRINTING APPARATUS AND METHOD OF PRINTING USING THE SAME

(71) Applicant: Samsung Display Co., LTD., Yongin-si (KR)

(72) Inventors: YEJIN KIM, Yongin-si (KR); DOOHYUN KIM, Yongin-si (KR); SEUL-GI KIM, Yongin-si (KR)

(21) Appl. No.: 18/942,171

(22) Filed: Nov. 8, 2024

(30) Foreign Application Priority Data
Nov. 28, 2023 (KR) 10-2023-0168160

(51) Int. Cl. B41J 3/54; B41J 11/06; B41M 3/00

(52) U.S. Cl. CPC B41J 3/543; B41J 11/06; B41M 3/008

(57) ABSTRACT

A printing apparatus includes a stage including a plane extending in a first direction and a second direction crossing the first direction, a first head including first nozzles facing the stage along the first direction, and a second head spaced apart from the first head and including second nozzles facing the stage along the first direction.

### CROSS-REFERENCE TO RELATED APPLICATION

The present application claims priority to and benefits of Korean Patent Application No. 10-2023-0168160, filed on Nov. 28, 2023, in the Korean Intellectual Property Office, the entire disclosure of which is incorporated herein by reference.

### BACKGROUND

### 1. Field

Aspects of some embodiments relate to a printing apparatus and a method of printing using the printing apparatus.

### 2. Description of the Related Art

A display device is a device that displays images for providing visual information to users. Among display devices, an organic light emitting diode display has recently attracted attention.

A printing apparatus including an inkjet head may be used to manufacture the display device. The printing apparatus may print an optical adhesive material on a display panel in an inkjet method.

The above information disclosed in this Background section is only for enhancement of understanding of the background and therefore the information discussed in this Background section does not necessarily constitute prior art.

### SUMMARY

Aspects of some embodiments relate to a printing apparatus and a method of printing using the printing apparatus. For example, aspects of some embodiments relate to a printing apparatus for manufacturing a display device and a method of printing using the printing apparatus.

Aspects of some embodiments include a printing apparatus with relatively improved quality.

Aspects of some embodiments include a method of printing using the printing apparatus.

A printing apparatus according to some embodiments includes a stage including a plane extending in a first direction and a second direction crossing the first direction, a first head including first nozzles facing the stage along the first direction, and a second head spaced apart from the first head and including second nozzles facing the stage along the first direction.

According to some embodiments, the first nozzles may include 1-1 nozzles overlapping the second nozzles in the second direction and 1-2 nozzles adjacent to the 1-1 nozzles.

According to some embodiments, the second nozzles may include 2-1 nozzles overlapping the first nozzles in the second direction and 2-2 nozzles adjacent to the 2-1 nozzles.

According to some embodiments, the 1-1 nozzles may be configured to gradually decrease an ink discharge amount as the 1-1 nozzles approaches the 2-2 nozzles.

According to some embodiments, the 2-1 nozzles may be configured to gradually decrease an ink discharge amount as the 2-1 nozzles approaches the 1-2 nozzles.

According to some embodiments, the ink discharge amount of the 1-1 nozzles may be greater than the ink discharge amount of the 2-1 nozzles.

According to some embodiments, the first nozzles may be configured to start to discharge ink before the second nozzles.

According to some embodiments, temperature of the first head may be higher than temperature of the second head.

According to some embodiments, the 1-1 nozzles may be configured to linearly decrease the ink discharge amount as the 1-1 nozzles approaches the 2-2 nozzles.

According to some embodiments, the 2-1 nozzles may be configured to linearly decrease the ink discharge amount as the 2-1 nozzles approaches the 1-2 nozzles.

According to some embodiments, the ink discharge amount of the 1-2 and the ink discharge amount of the 2-2 nozzles may be equal.

According to some embodiments, an ink discharge amount of a 1-1 nozzle closest to the 1-2 nozzles among the 1-1 nozzles may be equal to or greater than 80 percent (or about 80 percent) and equal to or less than 100 percent (or about 100 percent) of the ink discharge amount of the 1-2 nozzles.

According to some embodiments, an ink discharge amount of a 1-1 nozzle closest to the 2-2 nozzles among the 1-1 nozzles may be equal to or greater than 60 percent (or about 60 percent) and equal to or less than 80 percent (or about 80 percent) of the ink discharge amount of the 1-2 nozzles.

According to some embodiments, an ink discharge amount of a 2-1 nozzle closest to the 2-2 nozzles among the 2-1 nozzles may be equal to or greater than 20 percent (or about 20 percent) and equal to or less than 40 percent (or about 40 percent) of the ink discharge amount of the 2-2 nozzles.

According to some embodiments, an ink discharge amount of a 2-1 nozzle closest to the 1-2 nozzles among the 2-1 nozzles may be equal to or greater than 0 percent (or about 0 percent) and equal to or less than 20 percent (or about 20 percent) of the ink discharge amount of the 2-2 nozzles.

According to some embodiments, an ink discharged by the first nozzles and an ink discharged by the second nozzles may include a different type of materials.

A method of printing according to some embodiments includes discharging ink using first nozzles that are included in a first head and facing a stage along a first direction on a print object on the stage and discharging ink using second nozzles included in a second head and to facing the stage along the first direction on the print object, wherein the second head is spaced apart from the first head.

According to some embodiments, the first nozzles may include 1-1 nozzles overlapping the second nozzles in the second direction and 1-2 nozzles adjacent to the 1-1 nozzles.

According to some embodiments, the second nozzles may include 2-1 nozzles overlapping the first nozzles in the second direction and 2-2 nozzles adjacent to the 2-1 nozzles.

According to some embodiments, the 1-1 nozzles may be configured to gradually decrease an ink discharge amount as the 1-1 nozzles approaches the 2-2 nozzles.

According to some embodiments, the 2-1 nozzles may be configured to gradually decrease an ink discharge amount as the 2-1 nozzles approaches the 1-2 nozzles.

According to some embodiments, the ink discharge amount of the 1-1 nozzles may be greater than the ink discharge amount of the 2-1 nozzles.

According to some embodiments, discharging ink using the first nozzles may start before discharging ink using the second nozzles.

According to some embodiments, temperature of the first head may be higher than temperature of the second head.

According to some embodiments, the ink discharge amount of the 1-2 and the ink discharge amount of the 2-2 nozzles may be equal.

According to some embodiments, an ink discharge amount of a 1-1 nozzle closest to the 1-2 nozzles among the 1-1 nozzles may be equal to or greater than 80 percent (or about 80 percent) and equal to or less than 100 percent (or about 100 percent) of the ink discharge amount of the 1-2 nozzles.

According to some embodiments, an ink discharge amount of a 1-1 nozzle closest to the 2-2 nozzles among the 1-1 nozzles may be equal to or greater than 60 percent (or about 60 percent) and equal to or less than 80 percent (or about 80 percent) of the ink discharge amount of the 1-2 nozzles.

According to some embodiments, an ink discharge amount of a 2-1 nozzle closest to the 2-2 nozzles among the 2-1 nozzles may be equal to or greater than 20 percent (or about 20 percent) and equal to or less than 40 percent (or about 40 percent) of the ink discharge amount of the 2-2 nozzles.

According to some embodiments, an ink discharge amount of a 2-1 nozzle closest to the 1-2 nozzles among the 2-1 nozzles may be equal to or greater than 0 percent (or about 0 percent) and equal to or less than 20 percent (or about 20 percent) of the ink discharge amount of the 2-2 nozzles.

A printing apparatus according to some embodiments may include a stage including a plane extending in a first direction and a second direction crossing the first direction, a first head including first nozzles facing the stage along the first direction, and a second head spaced apart from the first head and including second nozzles facing the stage along the first direction. In addition, the first nozzles may include 1-1 nozzles overlapping the second nozzles in the second direction and 1-2 nozzles adjacent to the 1-1 nozzles. In addition, the second nozzles may include 2-1 nozzles overlapping the first nozzles in the second direction and 2-2 nozzles adjacent to the 2-1 nozzles. In addition, an ink discharge amount of the 1-1 nozzles may gradually decreases as the 1-1 nozzles approaches the 2-2 nozzles. In addition, an ink discharge amount of the 2-1 nozzles may gradually decreases as the 2-1 nozzles approaches the 1-2 nozzles.

Accordingly, ink may not be recognized as a stain in a portion of a print object where the first head and the second head overlap.

### BRIEF DESCRIPTION OF THE DRAWINGS

Illustrative, non-limiting embodiments will be more clearly understood from the following detailed description in conjunction with the accompanying drawings.

FIG. 1 is a perspective view illustrating a printing apparatus according to some embodiments.

FIGS. 2 and 3 are side views illustrating a method of operating the printing apparatus of FIG. 1 in time series.

FIG. 4 is a plan view illustrating a first head and a second head included in the printing apparatus of FIG. 1.

FIG. 5 is a graph illustrating an example of a ink discharge amount of each of first nozzles and second nozzles.

FIG. 6 is a graph illustrating another example of a ink discharge amount of each of the first nozzles and the second nozzles.

FIG. 7 is a perspective view illustrating a printing apparatus according to some embodiments.

FIG. 8 is a plan view illustrating a first head, a second head, and a third head included in the printing apparatus of FIG. 7.

FIG. 9 is a graph illustrating a ink discharge amount of each of first nozzles, second nozzles, and third nozzles.

### DETAILED DESCRIPTION

Hereinafter, display devices according to some embodiments will be described in more detail with reference to the accompanying drawings. The same reference numerals are used for the same components in the drawings, and some redundant descriptions of the same components may be omitted.

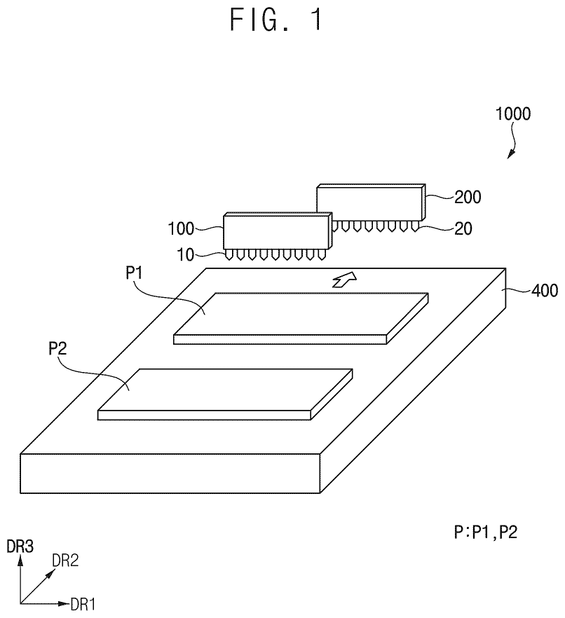

FIG. 1 is a perspective view illustrating a printing apparatus according to some embodiments.

Referring to FIG. 1, a printing apparatus 1000 according to some embodiments may include a first head 100, a second head 200, and a stage 400.

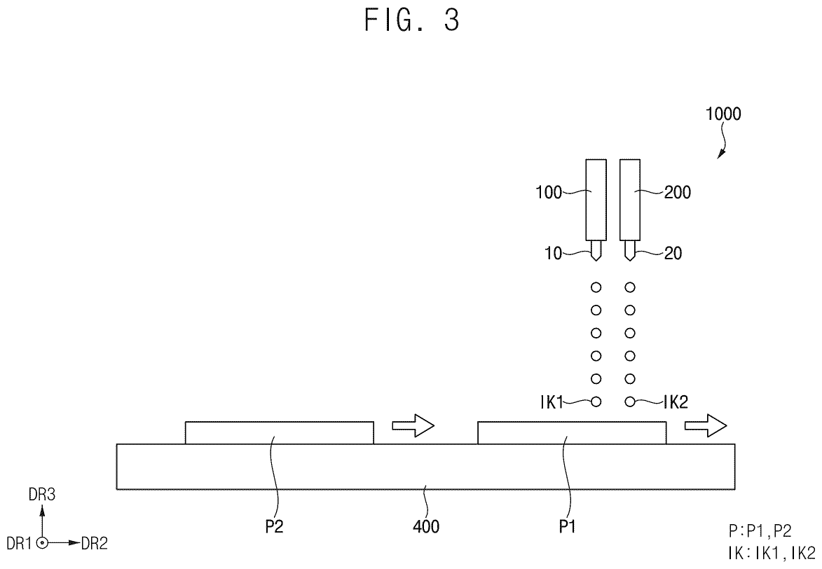

The printing apparatus 1000 may print a specific pattern by discharging ink (for example, a first ink IK1 or a second ink IK2 of FIG. 3) to a print object P. For example, the printing apparatus 1000 may print an optical adhesive material on the print object P. The optical adhesive material may be an optically clear adhesive (“OCA”) or an optically clear resin (“OCR”). For example, the print object P may be a display panel.

The stage 400 may include a plane (or planar surface) extending in a first direction DR1 and a second direction DR2 crossing the first direction DR1. The print object P may be located on the stage 400. Thus, according to some embodiments, the stage 400 may include a planar top surface that is parallel to a plane defined by the first direction DR1 and the second direction DR2. The stage 400 may move the print object P in the second direction DR2. As the print object P moves in the second direction DR2, a specific pattern may be printed on the print object P even if the first head 100 and the second head 200 do not move. However, this disclosure is not limited thereto, and as the first head 100 and the second head 200 move in a direction opposite to the second direction DR2, a specific pattern may be printed on the print object P.

The print object P may include a first print object P1 and a second print object P2. Each of the first print object P1 and the second print object P2 may move in the second direction DR2. The first head 100 and the second head 200 may print a specific pattern on the first print object P1, and then print a specific pattern on the second print object P2.

The first head 100 may be located on the stage 400 and the print object P. That is, the first head 100 may be spaced apart from the stage 400 and the print object P in a third direction DR3.

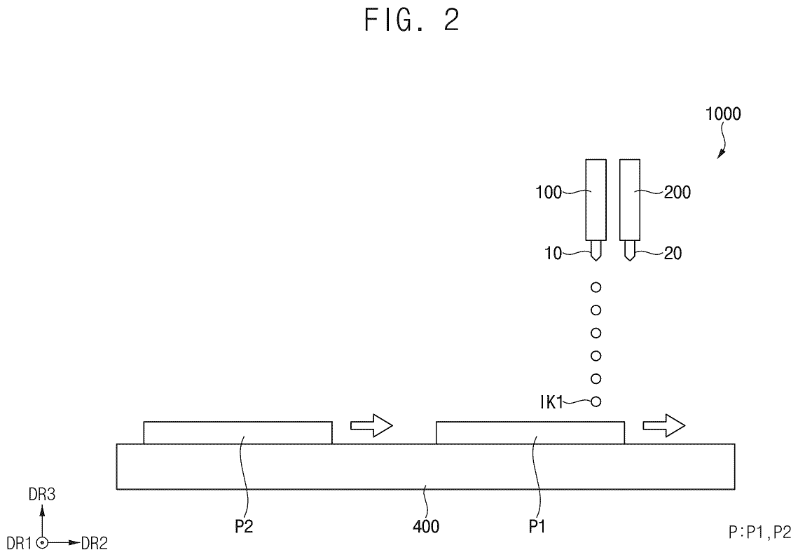

The first head 100 may include first nozzles 10. For example, the first nozzles 10 may be included in a lower surface of the first head 100. The first nozzles 10 may be arranged along a first direction DR1. The first nozzles 10 may be arranged to face the stage 400. That is, the first nozzles 10 may be arranged to face in a direction opposite to the third direction DR3. Accordingly, the first nozzles 10 may discharge a first ink (for example, a first ink IK1 of FIG. 2) to the moving print object P.

The second head 200 may be located on the stage 400 and the print object P. That is, the second head 200 may be spaced apart from the stage 400 and the print object P in the third direction DR3. The second head 200 may be spaced apart from the first head 100. For example, the first head 100 and the second head 200 may have different coordinates in the first direction DR1, different coordinates in the second direction DR2, and same coordinates in the third direction DR3. However, embodiments according to the present disclosure are not limited thereto, and the coordinates of the first head 100 and the second head 200 may be different from each other in the third direction DR3.

According to some embodiments, the first head 100 and the second head 200 may partially overlap each other in the second direction DR2. That is, the first head 100 may include a portion having the same coordinate as the second head 200 in the first direction DR1, and the second head 200 may include a portion having the same coordinate as the first head 100 in the first direction DR1.

The second head 200 may include second nozzles 20. For example, the second nozzles 20 may be included in a lower surface of the second head 200. The second nozzles 20 may be arranged along a first direction DR1. The second nozzles 20 may be arranged to face the stage 400. That is, the second nozzles 20 may be arranged to face in a direction opposite to the third direction DR3. Accordingly, the second nozzles 20 may discharge a second ink (for example, a second ink IK2 of FIG. 3) to the moving print object P.

FIGS. 2 and 3 are side views illustrating a method of operating the printing apparatus of FIG. 1 in time series.

Referring to FIG. 2, the first nozzles 10 may discharge a first ink IK1 to the first print object P1. While the first nozzles 10 discharge the first ink IK1 at a fixed position, each of the first print object P1 and the second print object P2 may move in the second direction DR2.

Referring further to FIG. 3, the second nozzles 20 may discharge the second ink IK2 to the first print object P1. According to some embodiments, the first nozzles 10 may start to discharge ink earlier than the second nozzles 20. That is, discharging the first ink IK1 using the first nozzles 10 may start before discharging the second ink IK2 using the second nozzles 20.

However, embodiments according to the present disclosure are not limited thereto, and according to some embodiments, discharging the first ink IK1 using the first nozzles 10 may start simultaneously or concurrently (or substantially simultaneously) with discharging the second ink IK2 using the second nozzles 20.

According to some embodiments, discharging the second ink IK2 using the second nozzles 20 may start before discharging the first ink IK1 using the first nozzles 10.

The first nozzles 10 and the second nozzles 20 may print a specific pattern on the first print object P1 and then print a specific pattern on the second print object P2.

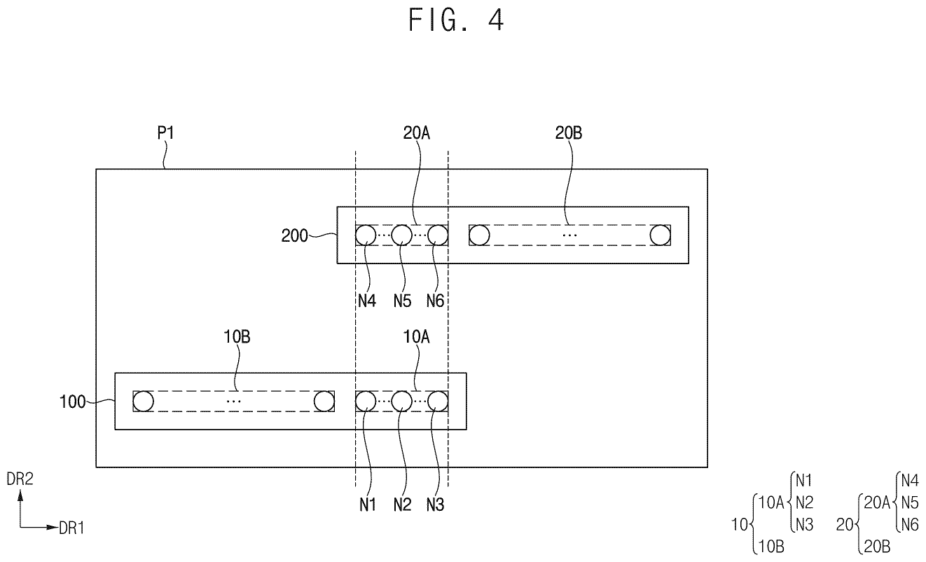

FIG. 4 is a plan view illustrating a first head and a second head included in the printing apparatus of FIG. 1. For example, FIG. 4 is a plan view illustrating a first head and a second head located on the first print object.

Referring to FIG. 4, the first nozzles 10 may include 1-1 nozzles 10A and 1-2 nozzles 10B. The 1-1 nozzles 10A may overlap the second nozzles 20 in the second direction DR2. The 1-2 nozzles 10B may not overlap the second nozzles 20 in the second direction DR2. The 1-2 nozzles 10B may be adjacent to the 1-1 nozzles 10A. For example, the 1-2 nozzles 10B may be adjacent to the 1-1 nozzles 10A in a direction opposite to the first direction DR1.

The second nozzles 20 may include 2-1 nozzles 20A and 2-2 nozzles 20B. The 2-1 nozzles 20A may overlap the first nozzles 10 in the second direction DR2. The 2-2 nozzles 20B may not overlap the first nozzles 10 in the second direction DR2. The 2-2 nozzles 20B may be adjacent to the 2-1 nozzles 20A. For example, the 2-2 nozzles 20B may be adjacent to the 2-1 nozzles 20A in the first direction DR1.

For example, the 1-1 nozzles 10A may include a first nozzle N1, a second nozzle N2, and a third nozzle N3. The first nozzle N1 may be adjacent to the 1-2 nozzles 10B in the first direction DR1. The second nozzle N2 may be arranged in the first direction DR1 of the first nozzle N1. A plurality of nozzles may be located between the first nozzle N1 and the second nozzle N2. In addition, the third nozzle N3 may be arranged in the first direction DR1 of the second nozzle N2. A plurality of nozzles may be located between the second nozzle N2 and the third nozzle N3.

For example, the 2-1 nozzles 20A may include a fourth nozzle N4, a fifth nozzle N5, and a sixth nozzle N6. The fifth nozzle N5 may be arranged in the first direction DR1 of the fourth nozzle N4. A plurality of nozzles may be located between the fourth nozzle N4 and the fifth nozzle N5. In addition, the sixth nozzle N6 may be arranged in the first direction DR1 of the fifth nozzle N5. A plurality of nozzles may be located between the fifth nozzle N5 and the sixth nozzle N6. The sixth nozzle N6 may be adjacent to the 2-2 nozzles 20B in a direction opposite to the first direction DR1.

For example, the fourth nozzle N4 may overlap the first nozzle N1 in the second direction DR2. That is, the fourth nozzle N4 and the first nozzle N1 may have the same coordinates in the first direction DR1. In addition, the fifth nozzle N5 may overlap the second nozzle N2 in the second direction DR2. That is, the fifth nozzle N5 and the second nozzle N2 may have the same coordinates in the first direction. In addition, the sixth nozzle N6 may overlap the third nozzle N3 in the second direction DR2. That is, the sixth nozzle N6 and the third nozzle N3 may have the same coordinates in the first direction DR1.

The 1-1 nozzles 10A may discharge the first ink (for example, the first ink IK1 of FIG. 3) to a first position of a surface of the first print object P1. Thereafter, the 2-1 nozzles 20A may discharge the second ink (for example, the second ink IK2 of FIG. 3) to the first position of the surface of the first print object P1.

Accordingly, the first ink and the second ink may contact at the first position of the surface of the first print object P1. If temperature of the first ink and temperature of the second ink are different, each of the first ink and the second ink may be visually recognized as a stain at the first position of the surface of the first print object P1. This may be because if the temperature of the first ink and the temperature of the second ink are different, surface tension of the first ink and surface tension of the second ink are different. However, embodiments according to the present disclosure are not limited thereto, and reasons why each of the first ink and the second ink is visually recognized as a stain may vary.

According to some embodiments, temperature of the first head 100 may be higher than temperature of the second head 200. For example, temperature of the first nozzles 10 may be higher than temperature of the second nozzles 20. For example, temperature of the 1-1 nozzles 10A may be higher than temperature of the 2-1 nozzles 20A. Accordingly, temperature of the first ink when the first ink is discharged from the 1-1 nozzles 10A may be higher than temperature of the second ink when the second ink is discharged from the 2-1 nozzles 20A.

As described above, the first ink may reach the first position of the surface of the first print object P1 before the second ink reaches the first position of the surface of the first print object P1. The temperature of the first ink may gradually decrease at the first position of the surface of the first print object P1. That is, the first ink may have a first temperature when the first ink reaches the first position of the surface of the first print object P1, and may have a second temperature lower than the first temperature when the second ink reaches the first position (or a position adjacent to the first position) of the surface of the first print object P1. The second ink may have a third temperature when the second ink reaches the first position of the surface of the first print object P1. By setting temperature of the first ink when the first ink is discharged from the 1-1 nozzles 10A to be higher than temperature of the second ink when the second ink is discharged from the 2-1 nozzles 20A, the second temperature and the third temperature may be adjusted the same (or substantially the same). Accordingly, each of the first ink and the second ink may not be visually recognized as a stain at the first position of the surface of the first print object P1.

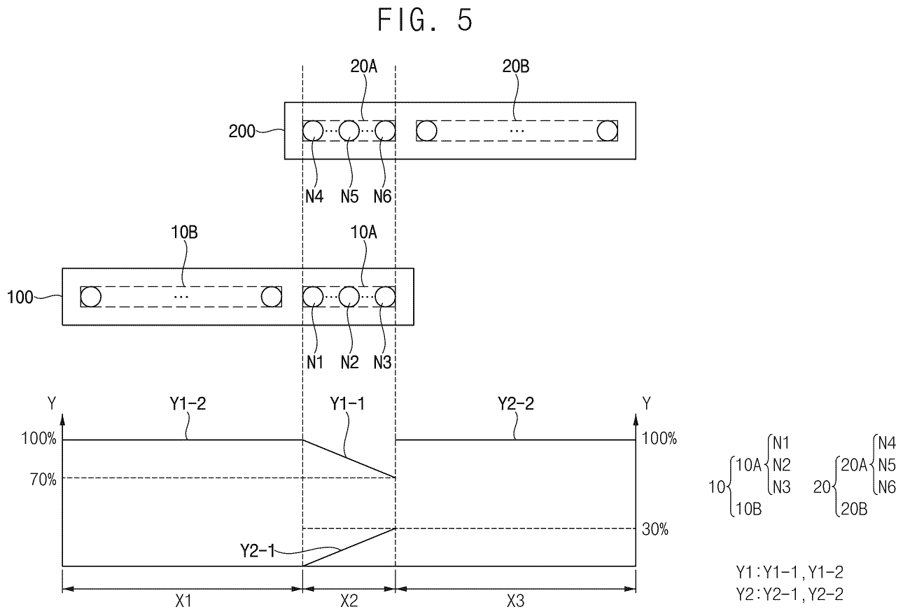

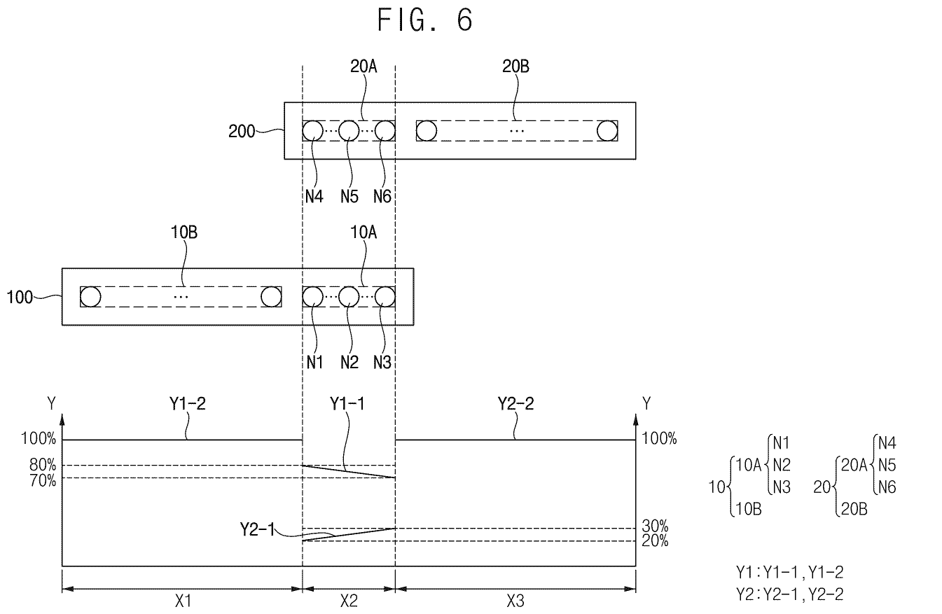

FIG. 5 is a graph illustrating an example of a ink discharge amount of each of first nozzles and second nozzles. FIG. 6 is a graph illustrating another example of a ink discharge amount of each of the first nozzles and the second nozzles.

Referring to FIG. 5, a graph of FIG. 5 may distinguish an ink discharge amount Y according to a first area X1, a second area X2, and a third area X3. For example, the first area X1 may be an area corresponding to the 1-2 nozzles 10B. The third area X3 may be an area corresponding to the 2-1 nozzles 20B. The second area X2 may be an area corresponding to the 1-1 nozzles 10A and the 2-1 nozzles 20A. That is, the second area X2 may be an area in which the first nozzles 10 and the second nozzles 20 overlap each other in the second direction (e.g., the second direction DR2 of FIG. 4).

For example, a first discharge amount Y1 may represent an ink discharge amount of the first nozzles 10, and a second discharge amount Y2 may represent an ink discharge amount of the second nozzles 20. For example, a 1-1 discharge amount Y1-1 may represent an ink discharge amount of the 1-1 nozzles 10A, and a 1-2 discharge amount Y1-2 may represent an ink discharge amount of the 1-2 nozzles 10B. For example, a 2-1 discharge amount Y2-1 may represent an ink discharge amount of the 2-1 nozzles 20A, and a 2-2 discharge amount Y2-2 may represent an ink discharge amount of the 2-2 nozzles 20B.

According to some embodiments, the 1-2 discharge amount Y1-2 and the 2-2 discharge amount Y2-2 may be the same (or substantially the same). In the following specification, it is assumed that each of the 1-2 discharge amount Y1-2 and the 2-2 discharge amount Y2-2 is 100% (or about 100%).

According to some embodiments, the ink discharge amount of the 1-1 nozzles 10A may gradually decrease as the 1-1 nozzles 10A approaches the 2-2 nozzles 20B. That is, the 1-1 discharge amount Y1-1 may gradually decrease as the 1-1 discharge amount Y1-1 approaches the third area X3. For example, an ink discharge amount of the second nozzle N2 may be less than an ink discharge amount of the first nozzle N1, and an ink discharge amount of the third nozzle N3 may be less than the ink discharge amount of the second nozzle N2.

According to some embodiments, the 1-1 discharge amount Y1-1 may linearly decrease as the 1-1 discharge amount Y1-1 approaches the third area X3. However, embodiments according to the present disclosure are not limited thereto, and according to some embodiments, the 1-1 discharge amount Y1-1 may decrease in a curved shape as the 1-1 discharge amount Y1-1 approaches the third area X3.

According to some embodiments, the ink discharge amount of the first nozzle N1 closest to the 1-2 nozzles 10B among the 1-1 nozzles 10A may be equal to or greater than 80 percent (or about 80 percent) and equal to or less than 100 percent (or about 100 percent) of the 1-2 discharge amount Y1-2. For example, as shown in FIG. 5, the ink discharge amount of the first nozzle N1 may be 100 percent (or about 100 percent) of the 1-2 discharge amount Y1-2.

According to some embodiments, the ink discharge amount of the third nozzle N3 closest to the 2-2 nozzles 20B among the 1-1 nozzles 10A may be equal to or greater than 60 percent (or about 60 percent) and equal to or less than 80 percent (or about 80 percent) of the 1-2 discharge amount Y1-2. For example, as shown in FIG. 5, the ink discharge amount of the third nozzle N3 may be 70 percent (or about 70 percent) of the 1-2 discharge amount Y1-2.

That is, as shown in FIG. 5, the 1-1 discharge amount Y1-1 may decrease from 100 percent (or about 100 percent) to 70 percent (or about 70 percent) as the 1-1 discharge amount Y1-1 approaches the third area X3.

According to some embodiments, an ink discharge amount of the 2-1 nozzles 20A may gradually decrease as the 2-1 nozzles 20A approaches the 1-2 nozzles 10B. That is, the 2-1 discharge amount Y2-1 may gradually decrease as the 2-1 discharge amount Y2-1 approaches the first area X1. For example, an ink discharge amount of the fifth nozzle N5 may be less than an ink discharge amount of the sixth nozzle N6, and an ink discharge amount of the fourth nozzle N4 may be less than the ink discharge amount of the fifth nozzle N5.

According to some embodiments, the 2-1 discharge amount Y2-1 may linearly decrease as the 2-1 discharge amount Y2-1 approaches the first area X1. However, embodiments according to the present disclosure are not limited thereto, and according to some embodiments, the 2-1 discharge amount Y2-1 may decrease in a curved shape as the 2-1 discharge amount Y2-1 approaches the first area X1.

According to some embodiments, the ink discharge amount of the sixth nozzle N6 closest to the 2-2 nozzles 20B among the 2-1 nozzles 20A may be equal to or greater than 20 percent (or about 20 percent) and equal to or less than 40 percent (or about 40 percent) of the 2-2 discharge amount Y2-2. For example, as shown in FIG. 5, the ink discharge amount of the sixth nozzle N6 may be 30 percent (or about 30 percent) of the 2-2 discharge amount Y2-2.

According to some embodiments, the ink discharge amount of the fourth nozzle N4 closest to the 1-2 nozzles 10B among the 2-1 nozzles 20A may be equal to or greater than 0 percent (or about 0 percent) and equal to or less than 20 percent (or about 20 percent) of the 2-2 discharge amount Y2-2. For example, as shown in FIG. 5, the ink discharge amount of the fourth nozzle N4 may be 0% (or about 0%) of the 2-2 discharge amount Y2-2.

That is, as shown in FIG. 5, the 2-1 discharge amount Y2-1 may decrease from 30 percent (or about 30 percent) to 0 percent (or about 0 percent) as the 2-1 discharge amount Y2-1 approaches the first area X1.

The 1-2 discharge amount Y1-2 in the first area X1, a sum of 1-1 discharge amount Y1-1 and the 2-1 discharge amount Y2-1 in the second area X2, and the 2-2 discharge amount Y2-2 in the third area X3 may be the same (or substantially the same). Accordingly, an ink discharge amount may be constant in the first area X1, the second area X2, and third area X3 of the print object P as a whole. That is, an ink may be evenly discharged in the entire area of the print object P in the first direction (for example, the first direction DR1 of FIG. 4).

For example, a sum of the ink discharge amount of the first nozzle N1 and the ink discharge amount of the fourth nozzle N4 may be the same (or substantially the same) as the ink discharge amount of each of the 1-2 nozzles 10B and the ink discharge amount of each of the 2-2 nozzles 20B. In addition, a sum of the ink discharge amount of the second nozzle N2 and the ink discharge amount of the fifth nozzle N5 may be the same (or substantially the same) as the ink discharge amount of each of the 1-2 nozzles 10B and the ink discharge amount of each of the 2-2 nozzles 20B. In addition, a sum of the ink discharge amount of the third nozzle N3 and the ink discharge amount of the sixth nozzle N6 may be the same (or substantially the same) as the ink discharge amount of each of the 1-2 nozzles 10B and the ink discharge amount of each of the 2-2 nozzles 20B. That is, the sum of the ink discharge amount of the first nozzle N1 and the ink discharge amount of the fourth nozzle N4, the sum of the ink discharge amount of the second nozzle N2 and the ink discharge amount of the fifth nozzle N5, and the sum of the ink discharge amount of the third nozzle N3 and the ink discharge amount of the sixth nozzle N6 may be the same (or substantially the same).

Referring to FIG. 6, for example, the ink discharge amount of the first nozzle N1 may be 80 percent (or about 80 percent) of the 1-2 discharge amount Y1-2. In addition, the ink discharge amount of the third nozzle N3 may be 70 percent (or about 70 percent) of the 1-2 discharge amount Y1-2. That is, the 1-1 discharge amount Y1-1 may decrease from 80 percent (or about 80 percent) to 70 percent (or about 70 percent) as the 1-1 discharge amount Y1-1 approaches the third area X3.

For example, the ink discharge amount of the sixth nozzle N6 may be 30 percent (or about 30 percent) of the 2-2 discharge amount Y2-2. In addition, the ink discharge amount of the fourth nozzle N4 may be 20 percent (or about 20 percent) of the 2-2 discharge amount Y2-2. That is, the 2-1 discharge amount Y2-1 may decrease from 30 percent (or about 30 percent) to 20 percent (or about 20 percent) as the 2-1 discharge amount Y2-1 approaches the first area X1.

Referring back to FIGS. 4 and 5, as described above, the first nozzles 10 may start to discharge ink before the second nozzles 20. In addition, the ink discharge amount of the 1-1 nozzles 10A may gradually decrease as the 1-1 nozzles 10A approaches the 2-2 nozzles 20B, and the ink discharge amount of the 2-1 nozzles 20A may gradually decrease as the 2-1 nozzles 20A approaches the 1-2 nozzles 10B.

Accordingly, ink (for example, the first ink INK1 and the second ink INK2 of FIG. 3) may not be recognized as a stain in a portion of the print object (for example, the print object P of FIG. 3) where the first head 100 and the second head 200 overlap in the second direction DR2. For example, the ink may not be visually recognized as a stain in the second area X2 of the print object. For example, the ink may not be visually recognized as a stain in vicinity of a boundary between the first area X1 and the second area X2 of the print object. For example, the ink may not be visually recognized as a stain in vicinity of a boundary between the second area X2 and the third area X3 of the print object.

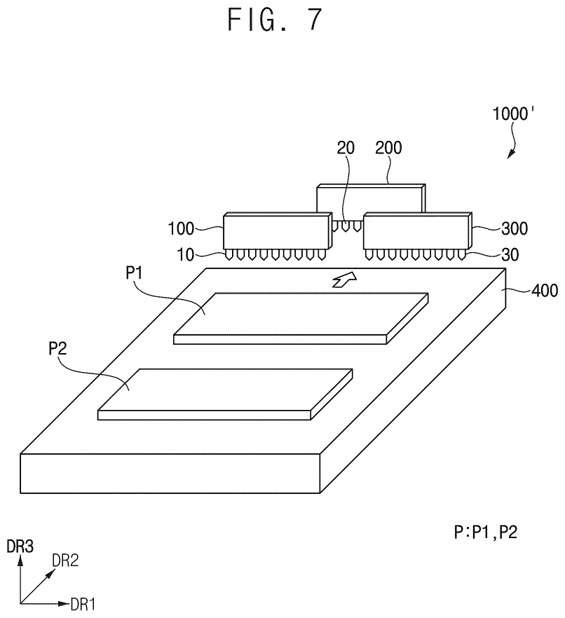

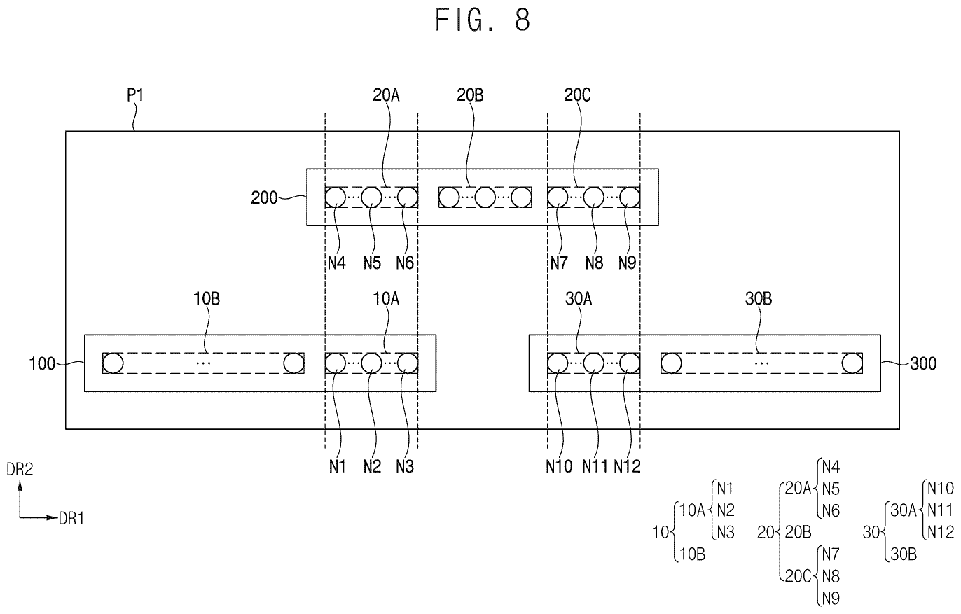

FIG. 7 is a perspective view illustrating a printing apparatus according to some embodiments. FIG. 8 is a plan view illustrating a first head, a second head, and a third head included in the printing apparatus of FIG. 7.

A printing apparatus 1000′ described with reference to FIGS. 7, 8, and 9 may differ only in presence of a third head 300 compared with the printing apparatus 1000 described with reference to FIGS. 1 2, 3, 4, 5, and 6. Accordingly, some overlapping descriptions may be briefly described or omitted.

Referring to FIGS. 7 and 8, a printing device 1000′ according to some embodiments may include a first head 100, a second head 200, a third head 300, and a stage 400.

The third head 300 may be located on the stage 400 and the print object P. That is, the third head 300 may be spaced apart from the stage 400 and the print object P in the third direction DR3. The third head 300 may be spaced apart from each of the first head 100 and the second head 200.

For example, the third head 300 may be spaced apart from the first head 100 in the first direction DR1. That is, the third head 300 may have different coordinates with the first head 100 in the first direction DR1, and may have the same coordinates with the first head 100 in the second direction DR2 and the third direction DR3. In addition, the third head 300 may have different coordinates with the second head 200 in the first direction DR1, may have different coordinates with the second head 200 in the second direction DR2, and may have the same coordinates with the second head 200 in the third direction DR3.

According to some embodiments, the second head 200 and the third head 300 may partially overlap each other in the second direction DR2. That is, the second head 200 may include a portion having the same coordinate as the third head 300 in the first direction DR1, and the third head 300 may include a portion having the same coordinate as the second head 200 in the first direction DR1.

The third head 300 may include third nozzles 30. For example, the third nozzles 30 may be included in a lower surface of the third head 300. The third nozzles 30 may be arranged along the first direction DR1. The third nozzles 30 may be arranged to face the stage 400. That is, the third nozzles 30 may be arranged to face in a direction opposite to the third direction DR3. Accordingly, the third nozzles 30 may discharge a third ink to the moving printing object P.

According to some embodiments, the third nozzles 30 may start to discharge ink simultaneously or concurrently (or substantially simultaneously) with the first nozzles 10. According to some embodiments, the first nozzles 10 and the third nozzles 30 may start to discharge ink before the second nozzles 20. That is, discharging the first ink using the first nozzles 10 and discharging the third ink using the third nozzles 30 may start before discharging the second ink using the second nozzles 20.

However, embodiments according to the present disclosure are not limited thereto, and according to some embodiments, discharging the first ink using the first nozzles 10, discharging the second ink using the second nozzles 20, and discharging the third ink using the third nozzles 30 may start simultaneously or concurrently (or substantially simultaneously).

According to some embodiments, discharging the second ink using the second nozzles 20 may start before discharging the first ink using the first nozzles 10 and discharging the third ink using the third nozzles 30.

According to some embodiments, discharging the first ink using the first nozzles 10 may start before discharging the third ink using the third nozzles 30, and discharging the third ink using the third nozzles 30 may start before discharging the second ink using the second nozzles 20.

Second nozzles 20 may include 2-1 nozzles 20A, 2-2 nozzles 20B and 2-3 nozzles 30C. The 2-1 nozzles 20A may overlap the first nozzles 10 in the second direction DR2. The 2-3 nozzles 20C may overlap third nozzles 30 in the second direction DR2. The 2-2 nozzles 20B may be adjacent to the 2-1 nozzles 20A and the 2-3 nozzles 20C. For example, the 2-2 nozzles 20B may be located between the 2-1 nozzles 20A and the 2-3 nozzles 20C.

The third nozzles 30 may include 3-1 nozzles 30A and 3-2 nozzles 30B. The 3-1 nozzles 30A may overlap the second nozzles 20 in the second direction DR2. The 3-2 nozzles 30B may not overlap the second nozzles 20 in the second direction DR2. The 3-2 nozzles 30B may be adjacent to the 3-1 nozzles 30A. For example, the 3-2 nozzles 30B may be adjacent to the 3-1 nozzles 30A in the first direction DR1.

For example, the 2-1 nozzles 20A may include a fourth nozzle N4, a fifth nozzle N5, and a sixth nozzle N6. The fifth nozzle N5 may be arranged in the first direction DR1 of the fourth nozzle N4. A plurality of nozzles may be located between the fourth nozzle N4 and the fifth nozzle N5. The sixth nozzle N6 may be arranged in the first direction DR1 of the fifth nozzle N5. A plurality of nozzles may be located between the fifth nozzle N5 and the sixth nozzle N6. The sixth nozzle N6 may be adjacent to the 2-2 nozzles 20B in a direction opposite to the first direction DR1.

For example, the 2-3 nozzles 20C may include a seventh nozzle N7, an eighth nozzle N8, and a ninth nozzle N9. The eighth nozzle N8 may be arranged in the first direction DR1 of the seventh nozzle N7. A plurality of nozzles may be located between the seventh nozzle N7 and the eighth nozzle N8. The seventh nozzle N7 may be adjacent to the 2-2 nozzles 20B in the first direction DR1. The ninth nozzle N9 may be arranged in the first direction DR1 of the eighth nozzle N8. A plurality of nozzles may be located between the eighth nozzle N8 and the ninth nozzle N9.

For example, the 3-1 nozzles 30A may include a tenth nozzle N10, an eleventh nozzle N11, and a twelfth nozzle N12. The eleventh nozzle N11 may be arranged in the first direction DR1 of the tenth nozzle N10. A plurality of nozzles may be located between the tenth nozzle N10 and the eleventh nozzle N11. The twelfth nozzle N12 may be arranged in the first direction DR1 of the eleventh nozzle N11. A plurality of nozzles may be located between the eleventh nozzle N11 and twelfth nozzle N12. The twelfth nozzle N12 may be adjacent to the 3-2 nozzles 30B in a direction opposite to the first direction DR1.

For example, the fourth nozzle N4 may overlap the first nozzle N1 in the second direction DR2. That is, the fourth nozzle N4 and the first nozzle N1 may have the same coordinates in the first direction DR1. In addition, the fifth nozzle N5 may overlap the second nozzle N2 in the second direction DR2. That is, the fifth nozzle N5 and the second nozzle N2 may have the same coordinates in the first direction. In addition, the sixth nozzle N6 may overlap the third nozzle N3 in the second direction DR2. That is, the sixth nozzle N6 and the third nozzle N3 may have the same coordinates in the first direction DR1.

For example, the seventh nozzle N7 may overlap the tenth nozzle N10 in the second direction DR2. That is, the seventh nozzle N7 and the tenth nozzle N10 may have the same coordinates in the first direction DR1. In addition, the eighth nozzle N8 may overlap the eleventh nozzle N11 in the second direction DR2. That is, the eighth nozzle N8 and the eleventh nozzle N11 may have the same coordinates in the first direction DR1. In addition, the ninth nozzle N9 may overlap the twelfth nozzle N12 in the second direction DR2. That is, the ninth nozzle N9 and the twelfth nozzle N12 may have the same coordinates in the first direction DR1.

FIGS. 7 and 8 may illustrate an example in which the printing apparatus 1000′ includes three heads, but this disclosure is not limited thereto, and the printing apparatus 1000′ may include four or more heads.

According to some embodiments, temperature of the third head 300 may be higher than temperature of the second head 200. For example, temperature of the third nozzles 30 may be higher than temperature of the second nozzles 20. For example, temperature of the 3-1 nozzles 30A may be higher than temperature of the 2-3 nozzles 20C. Accordingly, temperature of the third ink when the third ink is discharged from the 3-1 nozzles 30A may be higher than temperature of the second ink when the second ink is discharged from the 2-3 nozzles 20C.

According to some embodiments, when coordinate of the first head 100 in the second direction DR2 and coordinate of the third head 300 in the second direction DR2 are the same, the temperature of the third head 300 and the temperature of the first head 100 may be the same. For example, the temperature of the third nozzles 30 and the temperature of the first nozzles 10 may be the same.

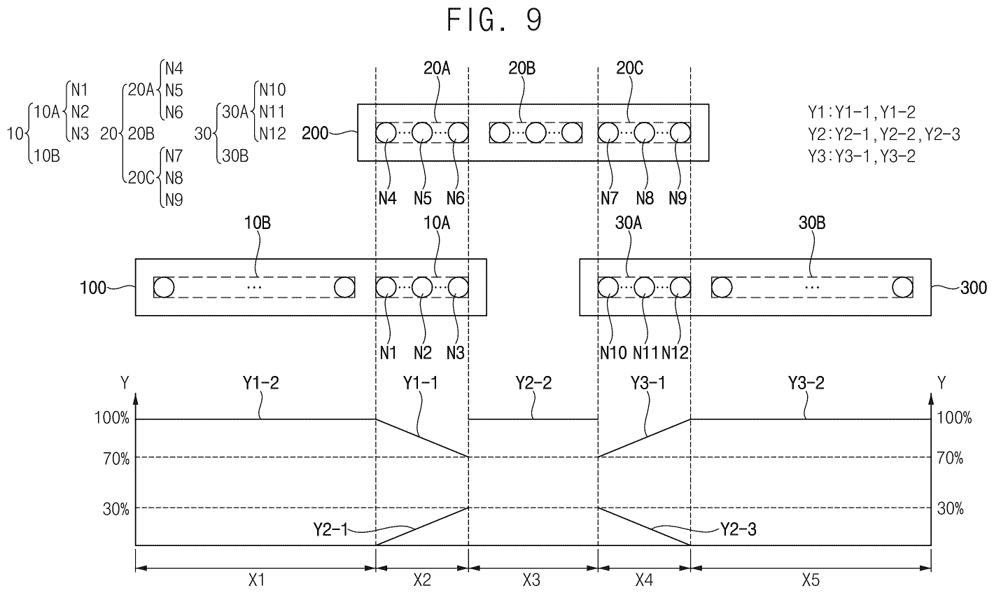

FIG. 9 is a graph illustrating an ink discharge amount of each of first nozzles, second nozzles, and third nozzles.

Referring to FIG. 9, a graph of FIG. 9 may distinguish an ink discharge amount Y according to a first area X1, a second area X2, a third area X3, a fourth area X4, and a fifth area X5. For example, the first area X1 may be an area corresponding to the 1-2 nozzles 10B. The third area X3 may be an area corresponding to the 2-2 nozzles 20B. The fifth area X5 may be an area corresponding to the 3-2 nozzles 30B.

The second area X2 may be a area corresponding to the 1-1 nozzles 10A and the 2-1 nozzles 20A. That is, the second area X2 may be an area in which the first nozzles 10 and the second nozzles 20 overlap in the second direction (e.g., the second direction DR2 of FIG. 4).

The fourth area X4 may be an area corresponding to the 3-1 nozzles 30A and the 2-3 nozzles 20C. That is, the fourth area X4 may be an area in which the second nozzles 20 and the third nozzles 30 overlap in the second direction.

For example, a first discharge amount Y1 may represent an ink discharge amount of the first nozzles 10, a second discharge amount Y2 may represent an ink discharge amount of the second nozzles 20, and a third discharge amount Y3 may represent an ink discharge amount of the third nozzles 30.

For example, a 1-1 discharge amount Y1-1 may represent an ink discharge amount of the 1-1 nozzles 10A, and a 1-2 discharge amount Y1-2 may represent an ink discharge amount of the 1-2 nozzles 10B.

For example, a 2-1 discharge amount Y2-1 may represent an ink discharge amount of the 2-1 nozzles 20A, a 2-2 discharge amount Y2-2 may represent an ink discharge amount of the 2-2 nozzles 20B, and a 2-3 discharge amount Y2-3 may represent an ink discharge amount of the 2-3 nozzles 20C.

For example, a 3-1 discharge amount Y3-1 may represent an ink discharge amount of the 3-1 nozzles 30A, and a 3-2 discharge amount Y3-2 may represent an ink discharge amount of the 3-2 nozzles 30B.

According to some embodiments, the 1-2 discharge amount Y1-2, the 2-2 discharge amount Y2-2, and the 3-2 discharge amount Y3-2 may be the same (or substantially the same). In the following specification, it is assumed that each of the 1-2 discharge amount Y1-2, the 2-2 discharge amount Y2-2, and the 3-2 discharge amount Y3-2 is 100% (or about 100%).

According to some embodiments, the 1-1 discharge amount Y1-1 may gradually decrease as the 1-1 discharge amount Y1-1 approaches the third area X3. For example, an ink discharge amount of the second nozzle N2 may be less than an ink discharge amount of the first nozzle N1, and an ink discharge amount of the third nozzle N3 may be less than an ink discharge amount of the second nozzle N2.

According to some embodiments, the 1-1 discharge amount Y1-1 may linearly decrease as the 1-1 discharge amount Y1-1 approaches the third area X3. However, embodiments according to the present disclosure are not limited thereto, and according to some embodiments, the 1-1 discharge amount Y1-1 may decrease in a curved shape as the 1-1 discharge amount Y1-1 approaches the third area X3.

According to some embodiments, the ink discharge amount of the first nozzle N1 closest to the 1-2 nozzles 10B among the 1-1 nozzles 10A may be equal to or greater than 80 percent (or about 80 percent) and equal to or less than 100 percent (or about 100 percent) of the 1-2 discharge amount Y1-2. For example, as shown in FIG. 9, the ink discharge amount of the first nozzle N1 may be 100 percent (or about 100 percent) of the 1-2 discharge amount Y1-2.

According to some embodiments, the ink discharge amount of the third nozzle N3 closest to the 2-2 nozzles 20B among the 1-1 nozzles 10A may be equal to or greater than 60 percent (or about 60 percent) and equal to or less than 800 percent (or about 800 percent) of the 1-2 discharge amount Y1-2. For example, as shown in FIG. 9, the ink discharge amount of the third nozzle N3 may be 70 percent (or about 70 percent) of the 1-2 discharge amount Y1-2.

That is, as shown in FIG. 9, the 1-1 discharge amount Y1-1 may decrease from 100 percent (or about 100 percent) to 70 percent (or about 70 percent) as the 1-1 discharge amount Y1-1 approaches the third area X3.

According to some embodiments, the 2-1 discharge amount Y2-1 may gradually decrease as the 2-1 discharge amount approaches the first area X1. For example, an ink discharge amount of the fifth nozzle N5 may be less than an ink discharge amount of the sixth nozzle N6, and an ink discharge amount of the fourth nozzle N4 may be less than the ink discharge amount of the fifth nozzle N5.

According to some embodiments, the 2-1 discharge amount Y2-1 may linearly decrease as the 2-1 discharge amount Y2-1 approaches the first area X1. However, embodiments according to the present disclosure are not limited thereto, and according to some embodiments, the 2-1 discharge amount Y2-1 may decrease in a curved shape as the 2-1 discharge amount Y2-1 approaches the first area X1.

According to some embodiments, the ink discharge amount of the sixth nozzle N6 closest to the 2-2 nozzles 20B among the 2-1 nozzles 20A may be equal to or greater than 20 percent (or about 20 percent) and equal to or less than 40 percent (or about 40 percent) of the 2-2 discharge amount Y2-2. For example, as shown in FIG. 9, the ink discharge amount of the sixth nozzle N6 may be 30 percent (or about 30 percent) of the 2-2 discharge amount Y2-2.

According to some embodiments, the ink discharge amount of the fourth nozzle N4 closest to the 1-2 nozzles 10B among the 2-1 nozzles 20A may be equal to or greater than 0 percent (or about 0 percent) and equal to or less than 20 percent (or about 20 percent) of the 2-2 discharge amount Y2-2. For example, as shown in FIG. 9, the ink discharge amount of the fourth nozzle N4 may be 0% (or about 0%) of the 2-2 discharge amount Y2-2.

That is, as shown in FIG. 9, the 2-1 discharge amount Y2-1 may decrease from 30 percent (or about 30 percent) to 0 percent (or about 0 percent) as the discharge amount Y2-1 approaches the first area X1.

According to some embodiments, the 2-3 discharge amount Y2-3 may gradually decrease as the 2-3 discharge approaches the fifth area X5. For example, an ink discharge amount of the eighth nozzle N8 may be less than an ink discharge amount of the seventh nozzle N7, and an ink discharge amount of the ninth nozzle N9 may be less than the ink discharge amount of the eighth nozzle N8.

According to some embodiments, the 2-3 discharge amount Y2-3 may linearly decrease as the 2-3 discharge amount Y2-3 approaches the fifth area X5. However, embodiments according to the present disclosure are not limited thereto, and according to some embodiments, the 2-3 discharge amount Y2-3 may decrease in a curved shape as the 2-3 discharge amount Y2-3 approaches the fifth area X5.

According to some embodiments, the ink discharge amount of the seventh nozzle N7 closest to the 2-2 nozzles 20B among the 2-3 nozzles 20C may be equal to or greater than 20 percent (or about 20 percent) and equal to or less than 40 percent (or about 40 percent) of the 2-2 discharge amount Y2-2. For example, as shown in FIG. 9, the ink discharge amount of the seventh nozzle N7 may be 30 percent (or about 30 percent) of the 2-2 discharge amount Y2-2.

According to some embodiments, the ink discharge amount of the ninth nozzle N9 closest to the 3-2 nozzles 30B among the 2-3 nozzles 20C may be equal to or greater than 0 percent (or about 0 percent) and equal to or less than 20 percent (or about 20 percent) of the 2-2 discharge amount Y2-2. For example, as shown in FIG. 9, the ink discharge amount of the ninth nozzle N9 may be 0% (or about 0%) of the 2-2 discharge amount Y2-2.

That is, as shown in FIG. 9, the 2-3 discharge amount Y2-3 may decrease from 30 percent (or about 30 percent) to 0 percent (or about 0 percent) as the 2-3 discharge amount Y2-3 approaches the fifth area X5.

According to some embodiments, the 3-1 discharge amount Y3-1 may gradually decrease as the 3-1 discharge amount Y3-1 approaches the third area X3. For example, an ink discharge amount of the eleventh nozzle N11 may be less than an ink discharge amount of the twelfth nozzle N12, and an ink discharge amount of the tenth nozzle N10 may be less than the ink discharge amount of the eleventh nozzle N11.

According to some embodiments, the 3-1 discharge amount Y3-1 may linearly decrease as the 3-2 discharge amount Y3-1 approaches the third area X3. However, embodiments according to the present disclosure are not limited thereto, and according to some embodiments, the 3-1 discharge amount Y3-1 may decrease in a curved shape as the 3-1 discharge amount approaches the third area X3.

According to some embodiments, the ink discharge amount of the twelfth nozzle N12 closest to the 3-2 nozzles 30B among the 3-1 nozzles 30A may be equal to or greater than 80 percent (or about 80 percent) and equal to or less than 100 percent (or about 100 percent) of the 3-2 discharge amount Y3-2. For example, as shown in FIG. 9, the ink discharge amount of the twelfth nozzle N12 may be 100 percent (or about 100 percent) of the 3-2 discharge amount Y3-2.

According to some embodiments, the ink discharge amount of the tenth nozzle N10 closest to the 2-2 nozzles 20B among the 3-1 nozzles 30A may be equal to or greater than 60 percent (or about 60 percent) and equal to or less than 80 percent (or about 80 percent) of the 3-2 discharge amount Y3-2. For example, as shown in FIG. 9, the ink discharge amount of the tenth nozzle N10 may be 70 percent (or about 70 percent) of the 3-2 discharge amount Y3-2.

That is, as shown in FIG. 9, the 3-1 discharge amount Y3-1 may decrease from 100 percent (or about 100 percent) to 70 percent (or about 70 percent) as the 3-1 discharge amount Y3-1 approaches the third area X3.

The 1-2 discharge amount Y1-2 in the first area X1, a sum of the 1-1 discharge amount Y1-1 and the 2-1 discharge amount Y2-1 in the second area X2, the 2-2 discharge amount Y2-2 in the third area X3, a sum of the 2-3 discharge amount Y2-3 and the 3-1 discharge amount Y3-1 in the fourth area X4, and the 3-2 discharge amount Y3-2 may be the same (or substantially the same). Accordingly, an ink discharge amount may be constant in the first area X1, the second area X2, the third area X3, the fourth area X4, and the fifth area X5 of the print object P as a whole. That is, an ink may be evenly discharged in the entire area of the print object P in the first direction (for example, the first direction DR1 of FIG. 8).

Referring further to FIG. 8, as described above, the third nozzles 30 may start to discharge ink before the second nozzles 20. In addition, the ink discharge amount of the 3-1 nozzles 30A may gradually decrease as the 3-1 nozzles 30A approaches the 2-2 nozzles 20B, and the ink discharge amount of the 2-3 nozzles 20C may gradually decrease as the 2-3 nozzles 20C approaches the 3-2 nozzles 30B.

Accordingly, the second ink and the third ink may not be recognized as a stain in a portion of the print object where the second head 200 and the third head 300 overlap in the second direction DR2. For example, the second ink and the third ink may not be visually recognized as a stain in the fourth area X4 of the print object. For example, the second ink and the third ink may not be visually recognized as a stain in vicinity of a boundary between the third area X3 and the fourth area X4 of the print object. For example, the second ink and the third ink may not be visually recognized as a stain in vicinity of a boundary between the fourth area X4 and the fifth area X5 of the print object.

Embodiments according to the present disclosure can be applied to various display devices. For example, embodiments according to the present disclosure may be applicable to various display devices such as display devices for vehicles, ships and aircraft, portable communication devices, display devices for exhibition or information transmission, medical display devices, and the like.

The foregoing is illustrative of embodiments and is not to be construed as limiting thereof. Although a few embodiments have been described, those skilled in the art will readily appreciate that many modifications are possible in the embodiments without materially departing from the novel teachings and advantages of the present inventive concept. Accordingly, all such modifications are intended to be included within the scope of the present inventive concept as defined in the claims, and their equivalents. Therefore, it is to be understood that the foregoing is illustrative of various embodiments and is not to be construed as limited to the specific embodiments disclosed, and that modifications to the disclosed embodiments, as well as other embodiments, are intended to be included within the scope of the appended claims, and their equivalents.

What is claimed is:

1. A printing apparatus comprising:
a stage including a plane extending in a first direction and a second direction crossing the first direction;
a first head including first nozzles facing the stage along the first direction; and
a second head spaced apart from the first head and including second nozzles facing the stage along the first direction,
wherein the first nozzles include 1-1 nozzles overlapping the second nozzles in the second direction and 1-2 nozzles adjacent to the 1-1 nozzles,
the second nozzles include 2-1 nozzles overlapping the first nozzles in the second direction and 2-2 nozzles adjacent to the 2-1 nozzles,
the 1-1 nozzles are configured to gradually decrease an ink discharge amount as the 1-1 nozzles approach the 2-2 nozzles, and
the 2-1 nozzles are configured to gradually decrease an ink discharge amount as the 2-1 nozzles approach the 1-2 nozzles.

2. The printing apparatus of claim 1, wherein the ink discharge amount of the 1-1 nozzles is greater than the ink discharge amount of the 2-1 nozzles.

3. The printing apparatus of claim 2, wherein the first nozzles are configured to start to discharge ink before the second nozzles.

4. The printing apparatus of claim 3, wherein temperature of the first head is higher than temperature of the second head.

5. The printing apparatus of claim 2, wherein the 1-1 nozzles are configured to linearly decrease the ink discharge amount as the 1-1 nozzles approaches the 2-2 nozzles.

6. The printing apparatus of claim 5, wherein the 2-1 nozzles are configured to linearly decrease the ink discharge amount as the 2-1 nozzles approaches the 1-2 nozzles.

7. The printing apparatus of claim 1, wherein the ink discharge amount of the 1-2 and the ink discharge amount of the 2-2 nozzles are equal.

8. The printing apparatus of claim 7, wherein an ink discharge amount of a 1-1 nozzle closest to the 1-2 nozzles among the 1-1 nozzles is equal to or greater than 80 percent and equal to or less than 100 percent of the ink discharge amount of the 1-2 nozzles.

9. The printing apparatus of claim 8, wherein an ink discharge amount of a 1-1 nozzle closest to the 2-2 nozzles among the 1-1 nozzles is equal to or greater than 60 percent and equal to or less than 80 percent of the ink discharge amount of the 1-2 nozzles.

10. The printing apparatus of claim 9, wherein an ink discharge amount of a 2-1 nozzle closest to the 2-2 nozzles among the 2-1 nozzles is equal to or greater than 20 percent and equal to or less than 40 percent of the ink discharge amount of the 2-2 nozzles.

11. The printing apparatus of claim 10, wherein an ink discharge amount of a 2-1 nozzle closest to the 1-2 nozzles among the 2-1 nozzles is equal to or greater than 0 percent and equal to or less than 20 percent of the ink discharge amount of the 2-2 nozzles.

12. The printing apparatus of claim 1, wherein an ink discharged by the first nozzles and an ink discharged by the second nozzles include a different type of materials.

13. A method of printing comprising:
discharging ink using first nozzles that are included in a first head and facing a stage along a first direction on a print object on the stage; and
discharging ink using second nozzles included in a second head and facing the stage along the first direction on the print object, wherein the second head is spaced apart from the first head,
wherein the first nozzles include 1-1 nozzles overlapping the second nozzles in the second direction crossing the first direction and 1-2 nozzles adjacent to the 1-1 nozzles,
the second nozzles include 2-1 nozzles overlapping the first nozzles in the second direction and 2-2 nozzles adjacent to the 2-1 nozzles,
the 1-1 nozzles are configured to gradually decrease an ink discharge amount as the 1-1 nozzles approaches the 2-2 nozzles, and
the 2-1 nozzles are configured to gradually decrease an ink discharge amount as the 2-1 nozzles approaches the 1-2 nozzles.

14. The method of claim 13, wherein the ink discharge amount of the 1-1 nozzles is greater than the ink discharge amount of the 2-1 nozzles.

15. The method of claim 14, wherein discharging ink using the first nozzles starts before discharging ink using the second nozzles.

16. The method of claim 15, wherein temperature of the first head is higher than temperature of the second head.

17. The method of claim 13, wherein the ink discharge amount of the 1-2 and the ink discharge amount of the 2-2 nozzles are equal, and
an ink discharge amount of a 1-1 nozzle closest to the 1-2 nozzles among the 1-1 nozzles is equal to or greater than 80 percent and equal to or less than 100 percent of the ink discharge amount of the 1-2 nozzles.

18. The method of claim 17, wherein an ink discharge amount of a 1-1 nozzle closest to the 2-2 nozzles among the 1-1 nozzles is equal to or greater than 60 percent and equal to or less than 80 percent of the ink discharge amount of the 1-2 nozzles.

19. The method of claim 18, wherein an ink discharge amount of a 2-1 nozzle closest to the 2-2 nozzles among the 2-1 nozzles is equal to or greater than 20 percent and equal to or less than 40 percent of the ink discharge amount of the 2-2 nozzles.

20. The method of claim 13, wherein an ink discharge amount of a 2-1 nozzle closest to the 1-2 nozzles among the 2-1 nozzles is equal to or greater than 0 percent and equal to or less than 20 percent of the ink discharge amount of the 2-2 nozzles.
